(19) United States
(12) Patent Application Publication
(10) Pub. No.: US 2019/0211966 A1
(43) Pub. Date: Jul. 11, 2019

(54) CASE ASSEMBLY WITH AN EXPANDABLE DEVICE

(71) Applicant: POPSOCKETS LLC, Boulder, CO (US)

(72) Inventors: Altan Nahum, Boulder, CO (US); Michael J. Kory, Boulder, CO (US); Randy Yang Chiang, Boulder, CO (US); Kendall Denike, Boulder, CO (US)

(21) Appl. No.: 16/232,423

(22) Filed: Dec. 26, 2018

Related U.S. Application Data
(60) Provisional application No. 62/669,807, filed on May 10, 2018.
(60) Provisional application No. 62/614,872, filed on Jan. 8, 2018.

(51) Int. Cl. F16M 13/06; A45C 11/00; F16M 13/04

(52) U.S. Cl. CPC F16M 13/06; A45C 11/00; F16M 13/04; A45C 2200/15; A45C 2011/002; A45F 2200/0508; A45F 2200/0516; A45C 2011/001

(57) ABSTRACT

A case assembly for a portable electronic device includes an expandable device having a device body with an end and a case body arranged to receive a portable electronic device on a first face. The case body includes an aperture formed in a second face, which is opposite the first face, and is sized to receive at least a portion of the expandable device. A buffer at least partially surrounds the aperture of the case body and includes a wall extending away from the first face of the case body. The wall is arranged to surround at least a portion of the device body when the expandable device is coupled to the case body. The device body is movable within the aperture from a first position to a second position.

### CROSS-REFERENCE TO RELATED APPLICATIONS

Priority is claimed to U.S. Provisional Patent Application No. 62/669,807, filed May 10, 2018, and U.S. Provisional Patent Application No. 62/614,872, filed Jan. 8, 2018, the entire contents of each of which are incorporated herein by reference.

### FIELD OF DISCLOSURE

The present disclosure relates generally to a case for a portable electronic device and more particularly to a case for a portable electronic device with an expandable device.

### BACKGROUND

Portable electronic devices, such as MP3 players and smart phones, are often housed in protective covers or cases in order to protect the device from damage, provide a grip for handling the device, and/or provide a stand for propping the device on a surface. Such cases increase the effective size of the device. Expandable devices, which may be attached directly to the device or to the case protecting the device, are used for a variety of functions, including propping the device on a surface and providing an expandable grip for handling the device. The expandable devices have decorative buttons, which may display logos, decals, symbols, or other artistic renderings.

### SUMMARY

In accordance with a first exemplary aspect, case assembly for a portable electronic device may include an expandable device including a device body having an end, a case body arranged to receive a portable electronic device, and a buffer. The case body may include a first face and an aperture formed in a second face opposite the first face. The aperture may be sized to receive at least a portion of the expandable device. The buffer may at least partially surround the aperture of the case body and may include a wall extending away from the first face of the case body. The wall may be arranged to surround at least a portion of the device body when the expandable device is coupled to the case body. The device body may be movable within the aperture from a first position to a second position.

In accordance with a second exemplary aspect, a case assembly for a portable electronic device may include device body having an end and a flexible wall that is movable between a collapsed configuration and an extended configuration. Further, a case body of the assembly may include a first face, a second face, and an aperture. The first face may be structured to receive a portable electronic device and the second face may define the aperture that is sized to receive at least a portion of the expandable device. The accessory may include a platform coupled to the end of the device body and movably coupled to the case body. A buffer may at least partially surround the aperture of the case body and may include a wall adjacent to the end of the device body when the expandable device is coupled to the case body. The device body may be movable in the aperture between a first position and a second position.

In accordance with a third exemplary aspect, a case assembly for a portable electronic device may include an expandable device including a device body having an end and a flexible wall that is movable between a collapsed configuration and an extended configuration. A case body may be structured to receive a portable electronic device and may include an aperture sized to receive at least a portion of the expandable device. A platform may be coupled to the end of the device body and may be movably coupled to the case body. A buffer may at least partially surround the aperture of the case body and may include a wall arranged to surround the end of the device body when the expandable device is coupled to the case body. The buffer may include an indent positioned adjacent to the aperture.

In accordance with a fourth exemplary aspect, a case assembly for a portable electronic device may include an expandable device having a device body with an end and a flexible wall that is movable between a collapsed configuration and an extended configuration. A case body may be structured to receive a portable electronic device and may include an aperture sized to receive at least a portion of the expandable device. A platform may be coupled to the end of the device body and may be movably coupled to the case body. A buffer may at least partially surround the aperture of the case body and may include a wall arranged to surround the end of the device body when the expandable device is coupled to the case body. The buffer may surround a circumference of the device body when the expandable device is in the collapsed configuration.

In accordance with a fifth exemplary aspect, a case assembly for a portable electronic device may include an expandable device having a device body with an end and a flexible wall that is movable between a collapsed configuration and an extended configuration. A case body may be structured to receive a portable electronic device and may include an aperture sized to receive at least a portion of the expandable device. A platform may be coupled to the end of the device body and may be movably coupled to the case body. A buffer may at least partially surround the aperture of the case body and may include a wall arranged to surround the end of the device body when the expandable device is coupled to the case body. At least a portion of the expandable device may be slidable within the aperture between a first position and a second position. The buffer wall may substantially surround the expandable device when the expandable device is in the first position. The buffer wall may define a sloped exterior surface of the case body extending at an incline from a first location away from the aperture to a second location adjacent to the aperture.

In accordance with a sixth exemplary aspect, a case assembly for a portable electronic device may include an expandable device having a device body with an end and a flexible wall that is movable between a collapsed configuration and an extended configuration. A case body may be structured to receive a portable electronic device and may include an aperture sized to receive at least a portion of the expandable device. A platform may be coupled to the end of the device body and may be movably coupled to the case body. A buffer may at least partially surround the aperture of the case body and may include a wall that extends at an incline to define a sloped exterior surface of the case body. The platform may be movable in the aperture between a first position and a second position. The buffer wall may substantially surround the expandable device when the expandable device is in the collapsed configuration and in the first position.

In accordance with a seventh exemplary aspect, a case assembly for a portable electronic device may include an expandable device having a device body with an end and a flexible wall that is movable between a collapsed configuration and an extended configuration. A case body may be structured to receive a portable electronic device and may include a first stepped area, a second stepped area raised relative to the first stepped area, and an aperture defining a track extending at least partially through the first stepped area and the second stepped area. A platform may be coupled to the end of the device body and may be movably coupled to the case body. A buffer may at least partially surround the aperture of the case body and may include a wall arranged to surround the end of the device body when the expandable device is coupled to the case body. The expandable device may be movable within the track between a first position, in which a portion of the device body is disposed in the first stepped area, and a second position, in which the portion of the device body is disposed in the second stepped area.

In accordance with a eighth exemplary aspect, a case assembly for a portable electronic device may include an expandable device having a device body with an end and a flexible wall that is movable between a collapsed configuration and an extended configuration. A case body may be structured to receive a portable electronic device and may include an aperture sized to receive at least a portion of the expandable device. A platform may be coupled to the end of the device body and may be movably coupled to the case body. A buffer may at least partially surround the aperture of the case body and may include a wall arranged to surround the end of the device body when the expandable device is coupled to the case body.

In accordance with a ninth exemplary aspect, a case assembly for a portable electronic device may include an expandable device having a device body with an end and a flexible wall that is movable between a collapsed configuration and an extended configuration. A case body may be structured to receive a portable electronic device and may include an aperture sized to receive at least a portion of the expandable device. A platform may be coupled to the end of the device body and may be movably coupled to the case body. A buffer may at least partially surround the aperture of the case body and may include a wall arranged to surround the end of the device body when the expandable device is coupled to the case body. A flexible joint may be connected to the platform and may be movable between a collapsed configuration, in which the platform is disposed in an initial position in the aperture and an extended configuration, in which the platform is disposed in a position above the initial position.

In accordance with a tenth exemplary aspect, a case assembly for a portable electronic device may include an expandable device having a device body with an end and a flexible wall that is movable between a collapsed configuration and an extended configuration. A case body may be structured to receive a portable electronic device and may include an aperture sized to receive at least a portion of the expandable device. A platform may be coupled to the end of the device body and may be movably coupled to the case body. A buffer may at least partially surround the aperture of the case body and may include a wall arranged to surround the end of the device body when the expandable device is coupled to the case body. An inflatable air pocket may be disposed in the aperture of the case body and may be adapted to engage with the expandable device. The air pocket may be deformable between an inflated configuration and a deflated configuration such that the end of the device body may be movable through the aperture of the case body between a first position and a second position.

In accordance with a eleventh exemplary aspect, a case assembly for a portable electronic device may include an expandable device having a device body with an end and a flexible wall that is movable between a collapsed configuration and an extended configuration. A case body may be structured to receive a portable electronic device and may include an aperture sized to receive at least a portion of the expandable device. The aperture may include a first groove and a second groove spaced from the first groove. A platform may be coupled to the end of the device body and may be movably coupled to the case body by snap-fit connection between the first groove and the second groove. A buffer may at least partially surround the aperture of the case body and may include a wall arranged to surround the end of the device body when the expandable device is coupled to the case body. The platform may include a resilient material and may bend to move the expandable device between a first position, in which the platform is disposed in the first groove and a second position, in which the platform is disposed in the second groove.

In accordance with a twelfth exemplary aspect, a case assembly for a portable electronic device may include an expandable device having a device body with an end and a flexible wall that is movable between a collapsed configuration and an extended configuration. A case body may be structured to receive a portable electronic device and may include an aperture sized to receive at least a portion of the expandable device. A platform may be coupled to the end of the device body and may be movably coupled to the case body. A buffer may at least partially surround the aperture of the case body and may include a wall arranged to surround the end of the device body when the expandable device is coupled to the case body. A flex band may be coupled to the platform and may be movable relative to the aperture of the case body. The flex band may be configured to flex away from the aperture to move the expandable device to a first position, in which the device body is disposed in the aperture, and may be configured to flex toward the aperture, in which the device body is disposed above the aperture in a second position.

In accordance with a thirteenth exemplary aspect, a case assembly for a portable electronic device may include an expandable device having a device body with an end and a flexible wall that is movable between a collapsed configuration and an extended configuration. A case body may be structured to receive a portable electronic device and may include an aperture sized to receive at least a portion of the expandable device. A platform may be coupled to the end of the device body and may be movably coupled to the case body. A buffer may at least partially surround the aperture of the case body and may include a wall arranged to surround the end of the device body when the expandable device is coupled to the case body. A spring may be disposed within the aperture and coupled to the platform. The spring may be movable between a compressed configuration and an extended configuration such that the platform of the device body may be movable through the aperture of the case body when the spring is in the extended configuration.

In accordance with a fourteenth exemplary aspect, a case assembly for a portable electronic device may include an expandable device having a device body with an end and a flexible wall that is movable between a collapsed configuration and an extended configuration. A case body may be structured to receive a portable electronic device and may include an aperture sized to receive at least a portion of the expandable device. The aperture may include a threaded surface. A platform may be coupled to the end of the device body and may be movably coupled to the case body. A buffer may at least partially surround the aperture of the case body and may include a wall arranged to surround the end of the device body when the expandable device is coupled to the case body. The expandable device may be rotatably coupled to the threaded surface of the aperture and may be movable in a perpendicular direction relative to the case body when the expandable device rotates relative to the case body.

In further accordance with any one or more of the foregoing first, second, third, fourth, fifth, sixth, seventh, eighth, ninth, tenth, eleventh, twelfth, thirteenth, or fourteenth aspects, a case assembly may further include any one or more of the following preferred forms.

In a preferred form, the device body may include a flexible wall that is movable between a collapsed configuration and an extended configuration. The buffer may at least partially surround the flexible wall when the expandable device is in the collapsed configuration.

In a preferred form, the end of the device body may be slidably coupled to the case body in the aperture between the first position and the second position.

In a preferred form, the end of the device body may be movable in a direction perpendicular relative to the first face of the case body between the first position and the second position.

In a preferred form, the end of the device body may be disposed on a first reference plane when the device body is in the first position. The end of the device body may be disposed on a second reference plane when the device body is in the second position. The second reference plane may be parallel and spaced away from the first reference plane.

In a preferred form, the end of the device body may be proximally located to the first face of the case body when the device body is disposed in the first position. The end of the device body may be spaced away from the first face of the case body when the device body is disposed in the second position.

In a preferred form, a flexible member may be connected to the case body and coupled to the end of the device body. The flexible member may be movable between a first configuration and an second configuration. The end of the device body may be movable through the aperture of the case body when the flexible member moves between the first configuration and the second configuration.

In a preferred form, the flexible member may be a pliable joint disposed within the aperture, and may be movable between a collapsed arrangement in the first configuration and an extended arrangement in the second configuration.

In a preferred form, the flexible member may be a compression spring disposed beneath the end of the device body, and may be movable between a compressed arrangement in the first configuration and an expanded arrangement in the second configuration.

In a preferred form, the flexible member may be coupled to the case body by snap-fit connection and may include a resilient material that bends to move the device body between the first position and the second position.

In a preferred form, the case body may include an inner threaded surface disposed adjacent the aperture. The expandable device may be rotatably coupled to the threaded surface and may be movable in a perpendicular direction relative to the case body when the expandable device rotates relative to the case body.

In a preferred form, an inflatable air pocket may be disposed in the aperture of the case body and adapted to engage with the expandable device. The air pocket may be deformable between an inflated configuration and a deflated configuration such that the end of the device body may be movable through the aperture of the case body between the first position and the second position.

In a preferred form, the buffer may extend substantially around a circumference of the device body when the expandable device is in the collapsed configuration.

In a preferred form, the expandable device may include a platform coupled to the end of the device body and coupled to the case body.

In a preferred form, the platform may be removably attached to at least one of the case body and the end of the device body.

In a preferred form, the buffer wall may define a sloped exterior surface of the case body extending at an incline from a first location away from the aperture to a second location adjacent to the aperture.

In a preferred form, the buffer may be integrally formed with the case body.

In a preferred form, the case body may include an interior shell and an exterior shell sized to wrap around the interior shell of the case body. At least one of the interior shell and the exterior shell may at least partially define the buffer.

In a preferred form, the buffer may include an indent positioned adjacent to the aperture.

### BRIEF DESCRIPTION OF THE DRAWINGS

FIG. 1 is a side view of a first exemplary case assembly for a portable electronic device constructed in accordance with the teachings of the present disclosure and showing an expandable device in a collapsed configuration;

FIG. 2 is a side view of the case assembly of FIG. 1 showing the expandable device in an extended configuration;

FIG. 3 is an exploded perspective view of a second exemplary case assembly for a portable electronic device constructed in accordance with the teachings of the present disclosure and showing a case body, an expandable device, and a shell;

FIG. 4 is a cross-sectional perspective view of the case assembly of FIG. 3 assembled and showing the expandable device in a collapsed configuration;

FIG. 5 is an exploded perspective view of a third exemplary case assembly for a portable electronic device constructed in accordance with the teachings of the present disclosure and showing a case body, an expandable device, and a shell;

FIG. 6A is a front perspective view of the case assembly of FIG. 5 showing the expandable device in an extended configuration;

FIG. 6B is a back elevational view of the case assembly of FIG. 5;

FIG. 6C is a side view of the case assembly of FIG. 5;

FIG. 7 is a perspective view of a fourth exemplary case assembly for a portable electronic device constructed in accordance with the teachings of the present disclosure and showing an expandable device in an extended configuration;

FIG. 8A is a side view of a fifth exemplary case assembly for a portable electronic device constructed in accordance with the teachings of the present disclosure and showing an expandable device in a first position and in a collapsed configuration;

FIG. 8B is a front elevational view of the case assembly of FIG. 8A;

FIG. 9 is a cross-sectional side view of the case assembly of FIG. 8A taken at A-A showing the expandable device in a second position and in the collapsed configuration;

FIG. 10 is an exploded partial perspective view of a sixth exemplary case assembly for a portable electronic device constructed in accordance with the teachings of the present disclosure and showing a case body and an expandable device;

FIG. 11 is a side view of the case assembly of FIG. 10 assembled and showing the expandable device in a collapsed configuration and in a first position;

FIG. 12 is a side view of the case assembly of FIG. 10 showing the expandable device in a second position;

FIG. 13 is a side view of the case assembly of FIG. 10 showing the expandable device in an extended configuration and in a second position;

FIG. 14 is a partial cross-sectional view of a seventh exemplary case assembly for a portable electronic device constructed in accordance with the teachings of the present disclosure and showing a case body and an expandable device in a collapsed configuration;

FIG. 15 is a cross-sectional view of the case assembly of FIG. 14 showing the expandable device in an extended configuration and in a first position;

FIG. 16 is a partial cross-sectional view of the case assembly of FIG. 14 showing the expandable device in an extended configuration and in a second position;

FIG. 17 is a partial cross-sectional view of an eighth exemplary case assembly for a portable electronic device constructed in accordance with the teachings of the present disclosure and showing a case body and an expandable device in a first position;

FIG. 18 is a partial cross-sectional view of the case assembly of FIG. 17 showing the expandable device in a second position;

FIG. 19 is a partial cross-sectional view of a ninth exemplary case assembly for a portable electronic device constructed in accordance with the teachings of the present disclosure and showing a case body and an expandable device in a first position;

FIG. 20 is a partial cross-sectional view of the case assembly of FIG. 19 showing the expandable device in a second position and in an extended configuration;

FIG. 21 is a cross-sectional view of a tenth exemplary case assembly for a portable electronic device constructed in accordance with the teachings of the present disclosure and showing a case body and an expandable device in a first position;

FIG. 22 is a cross-sectional view of the case assembly of FIG. 21 showing the expandable device in a second position;

FIG. 23 is a cross-sectional view of an eleventh exemplary case assembly for a portable electronic device constructed in accordance with the teachings of the present disclosure and showing a case body and an expandable device in a first position and in a collapsed configuration;

FIG. 24 is a cross-sectional view of the case assembly of FIG. 23 showing the expandable device in a second position and in an extended configuration;

FIG. 25 is a partial a cross-sectional view of a twelfth exemplary case assembly for a portable electronic device constructed in accordance with the teachings of the present disclosure and showing a case body and an expandable device in a first position and in a collapsed configuration;

FIG. 26 is a partial cross-sectional view of the case assembly of FIG. 25 showing the expandable device in a second position; and

FIG. 27 is a front perspective view of a thirteenth exemplary case assembly for a portable electronic device constructed in accordance with the teachings of the present disclosure and showing the expandable device in an extended configuration.

### DETAILED DESCRIPTION

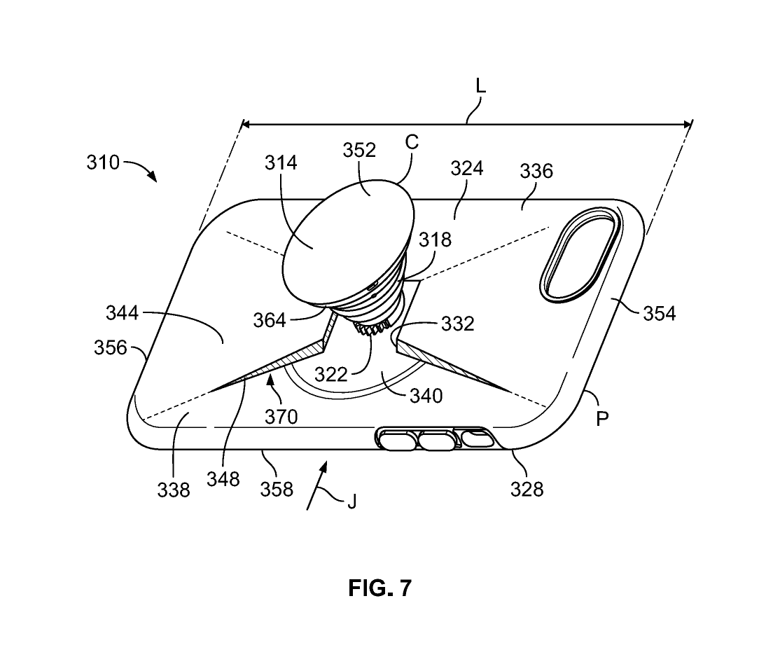

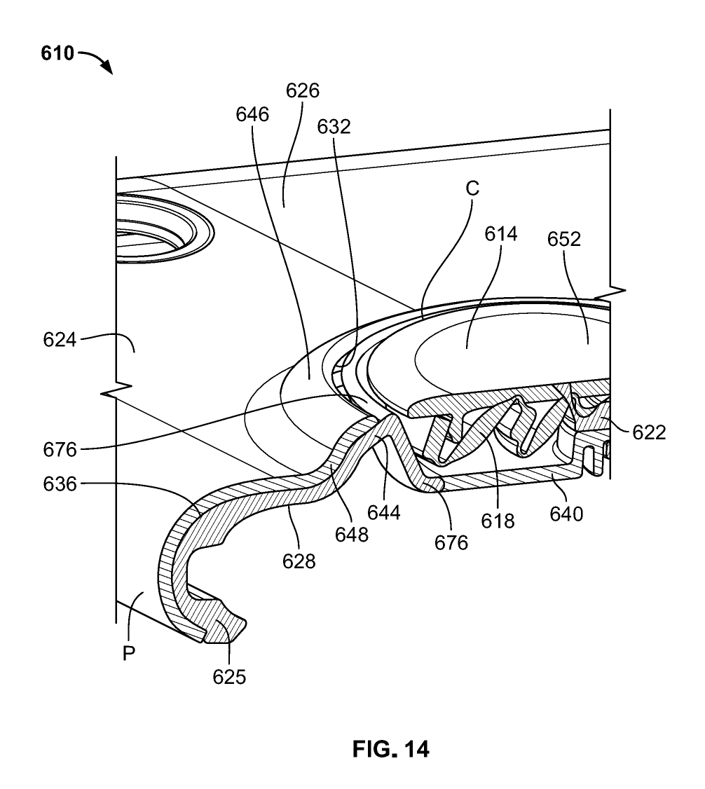

According to one or more examples of the present disclosure, a case assembly for a portable electronic device is designed and constructed to improve the pocketability of a portable electronic device with an attached or attachable expandable device. The expandable device of each case assembly is movable relative to an aperture formed in the case to improve pocketability. In each of the examples of FIGS. 1-6C and 27, an expandable device moves relative to a case body between an extended configuration and a collapsed configuration. In each of the examples of FIGS. 7-13, the expandable device slides relative to the case body between a storage position and an accessible position. Finally, in each of FIGS. 14-26, the expandable device moves in a perpendicular direction relative to the case body between a storage position and an accessible position.

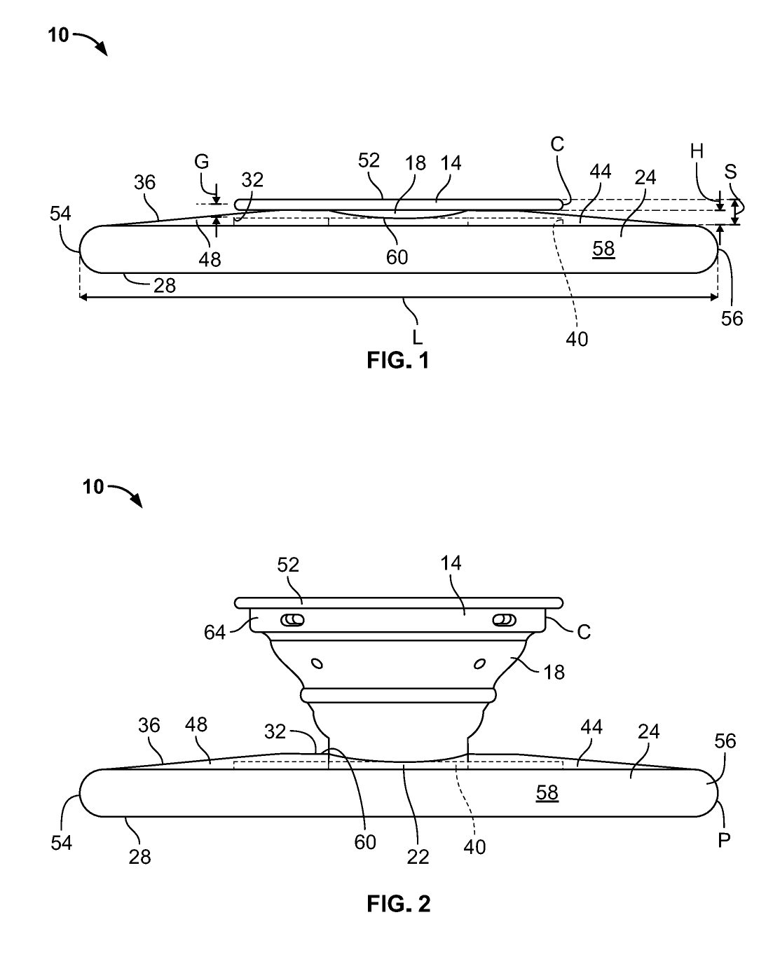

In FIGS. 1 and 2, a portable electronic device case assembly 10 is constructed in accordance with the teachings of the present disclosure to house a portable electronic device. The case 10 includes an expandable device 14 including a device body 18 having an end 22 coupled to a case body 24. The case body 24 is arranged to receive a portable electronic device on a first or interior face 28 and includes an aperture 32 formed in a second or exterior face 36. The aperture 32, which extends through or partially through the case body 24, is sized to receive at least a portion of the expandable device 14. In the first illustrated example, the expandable device 14 may be attached to the electronic device before or after the case body 24 is attached to the electronic device. The end 22 of the device body 18 is coupled to a platform 40, which may be part of the expandable device 14 or part of the case body 24. The case 10 includes a buffer 44 at least partially surrounding the aperture 32 of the case body 24. The buffer 44 includes a wall 48 extending away from the first face 28 of the case body 24. The wall 48 is arranged to surround at least a portion of the end 22 of the device body 18 when the expandable device 14 is coupled to the case body 24. The device body 18 is movable in the aperture 22 from a first or collapsed position, as shown in FIG. 1, to a second or extended position, as shown in FIG. 2.

In this example the buffer 44 is integrally formed with the case body 24. The wall 48 of the buffer 44 is shaped so that the second face 36 of the case body 24 gradually slopes or curves along a length L of the case body 24 in toward the aperture 32. When the expandable device 14 is in the collapsed configuration, the wall 48 of the buffer 44 surrounds a circumference C of the expandable device 14. In particular, the exterior surface 36 slopes to bridge a gap G defined as a distance from an exterior surface of a portable electronic device, in which the platform 40 of the expandable device 14 is attached, and a button 52 of the expandable device 14 when the expandable device 14 is in the collapsed configuration. The buffer 44 gradually inclines from the perimeter of the case 24 to reach a height H at the aperture 32. The height H may be configured to match or substantially match a height S of the expandable device 14 when the expandable device 14 is in the collapsed configuration. So configured, the buffer 44 may permit a first or second end 54, 56 of the case body 24 to slide into a pocket. The buffer 44 effectively and gradually widens the opening, or in other words, displaces the pocket outwardly, as the sloped surface 36 of the case 10 slides into the pocket. The buffer 44 may beneficially facilitate pocketing the case 10 and may reduce the likelihood that the expandable device 14 gets caught on the pocket while the case 10 is sliding into the pocket.

Along a width of the case assembly 10 (running into the page of FIGS. 1 and 2), the buffer wall 48 of the case 10 gradually inclines from first and second sides 58 of the case body 24 toward the aperture 32, which is centrally located relative to the case body 24 in this example. As best shown in FIG. 2, the wall 48 defines an indent 60 formed in the case (i.e. between the first and second sides 58) and adjacent the aperture 32. The indent 60 slightly exposes a portion of the expandable device 14 when the expandable device is in the collapsed configuration, as shown in FIG. 1. In the illustrated example, the indent 60 falls slightly below the button 52 of the expandable device 14 to permit a user to grip the button 52 and pull the expandable device 14 into the extended configuration. The arrangement of the buffer 44 and the indent 60 may beneficially facilitate a user's ability to smoothly pocket the case 10 lengthwise and to grip the expandable device 14 when the expandable device is in the collapsed configuration. In other examples, the indent 60 may be formed gradually along the length, width, or both the length and the width of the case body 24, or the indent 60 may be formed to partially or completely surround the aperture 32. The aperture 32 may have a circular or a non-circular shape.

In some instances, the expandable device 14 of the current disclosure may be attached to a platform 40 such as the expandable device disclosed in U.S. Pat. No. 8,560,031, U.S. Publication No. 2018/0288204, and U.S. application Ser. No. 15/864,509, filed Jan. 8, 2018, U.S. application Ser. No. 15/864,402, filed Jan. 8, 2018, and U.S. application Ser. No. 15/993,458, field May 30, 2018, the entire disclosures of which are incorporated herein by reference. The platform 40, shown in dashed lines in FIGS. 1 and 2 may be integrally formed with the case body 24 or may be disposed within the aperture 32 and below the second face 36 of the case body 24. Alternatively, the case of FIGS. 1 and 2 may be sized to fit around the expandable device 14 that is already attached to the portable electronic device. The aperture 32 may be sized so that a first end 64 of the expandable device 14 may pop through the aperture 32 while the second end 22 is attached to platform 40, and specifically, disposed between the first and second faces 28 and 36 of the case body 24.

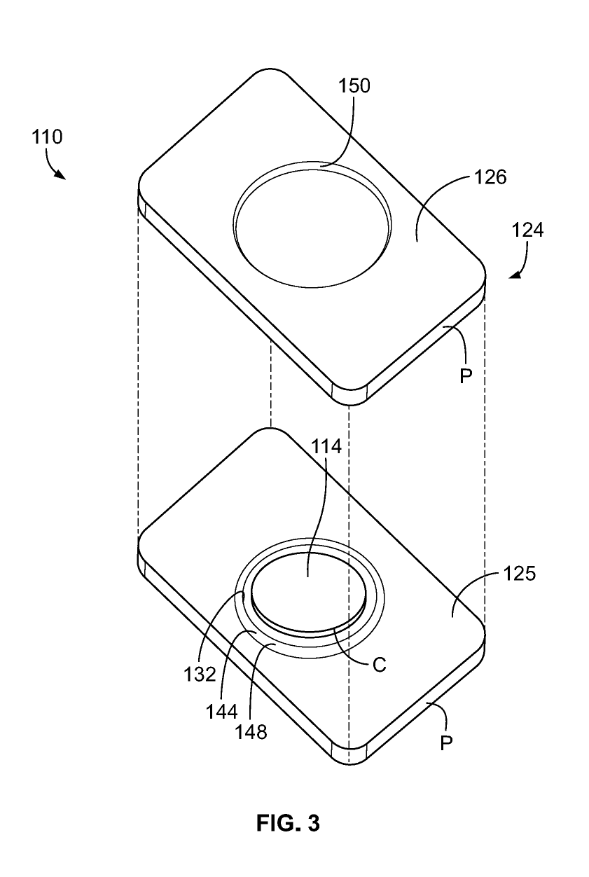

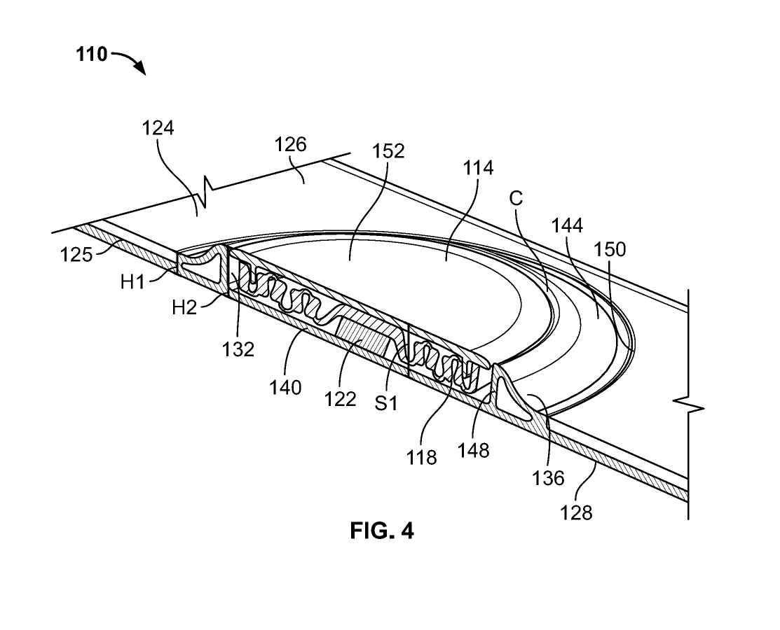

FIGS. 3 and 4 illustrate a second exemplary case assembly 110 for a portable electronic device constructed in accordance with the teachings of the present disclosure. The second exemplary case 110 is similar to the first exemplary case 10 described above, thus for ease of reference and to the extent possible, the same or similar components of the second exemplary case 110 in FIGS. 3 and 4 will retain the same reference numbers as outlined above with respect to the first exemplary case 10, although the reference numbers will be increased by 100. A description of many of these elements is abbreviated or even eliminated in the interest of brevity. However, the second exemplary case 110 differs from the first exemplary case 10 in the manner discussed below.

By comparison to the first exemplary case assembly 10, the case assembly 110 of FIGS. 3 and 4 includes a case body 124 having an interior shell 125 and an exterior case or shell 126 that fits over interior shell 125 of the case body 124. The case body 124 wraps around a portable device (not shown) and the interior shell 125 may provide a cushion between the device and the exterior shell 126. As shown in FIG. 3, an aperture 132 is formed in the case body 124 and is centrally located relative to the case body 124. When in the collapsed configuration, an expandable device 114 is nested within the aperture 132 and surrounded by a wall 148 of a buffer 144. The exterior shell 126 has a bore 150 sized to fit around the wall 148 of the buffer 144 and is aligned with the center of the aperture 132 formed in the case body 124.

In FIG. 4, the second exemplary case assembly 110 is assembled such that the exterior shell 126 is coupled or attached to the interior shell 125 and the wall 148 of the buffer 144 extends from a generally flat exterior surface 136 of the case body 124. A height of the buffer wall 148 slopes or increases toward the aperture 132 from a first height H1 to a second height H2, forming a contoured ring around the expandable device 114. The second height H2 of the wall 148 may be planar or substantially planar with a height 51 of the expandable device 114 when the expandable device 114 is in the collapsed configuration. The buffer 144 completely surrounds both the aperture 132 and an outer circumference C of the expandable device 114. So configured, the buffer 144 provides a barrier around a device body 118 of the expandable device 114. For example, when the case 110 is pocketed, the buffer 144 may gradually widen an opening of the pocket such that the pocket is wide enough to receive the case 110 having the attached expandable device 114 without the device 114 catching on the pocket.

As shown in FIG. 4, a platform 140 is disposed below the aperture 132 formed in the case body 124 and may be attached or integrally formed with the case body 124. The second end 122 of the expandable device 114 is removably coupled to the case body 124 via the platform 140. In some examples, the platform 140 may be configured to releasably couple to the device body 118 of the expandable device 114 so that the device body 118 may be easily removed and replaced with another device body 118. For example, the end 122 of the device body 118 may be coupled to the platform 140 by rotating, sliding, or press-fitting the end 122 of the device body 118 into and out of the platform 140. However, in another example, the device body 118 of the expandable device 114 is securely attached to the case body 124 of the case 110 and a button 152 may be removably attached to the body 118 of the expandable device 114. The case body 124 may be made of a soft, flexible material such as, for example, silicone. The platform 140 may be a different material and is preferably made of a durable plastic, such as polyethylene, or a harder plastic, such as polycarbonate, that may be formed by injection molding, thermoforming, or compression molding, or of any other suitable and durable material including thermoplastic polyurethane, metal, fiberglass, or any combination of these materials, or any equivalently functional materials suitable for its intended purpose.

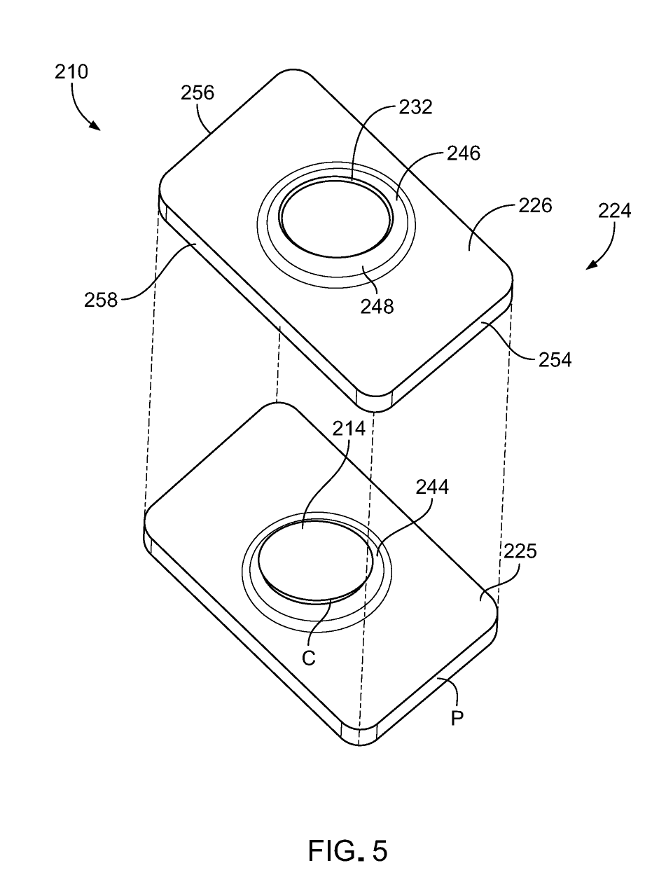

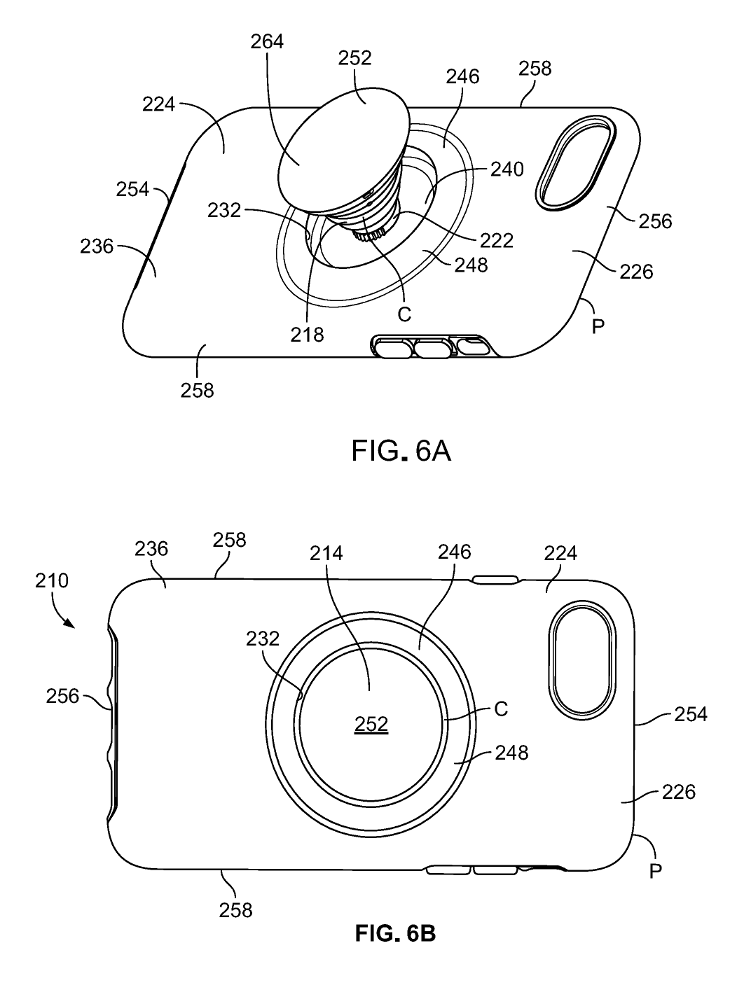

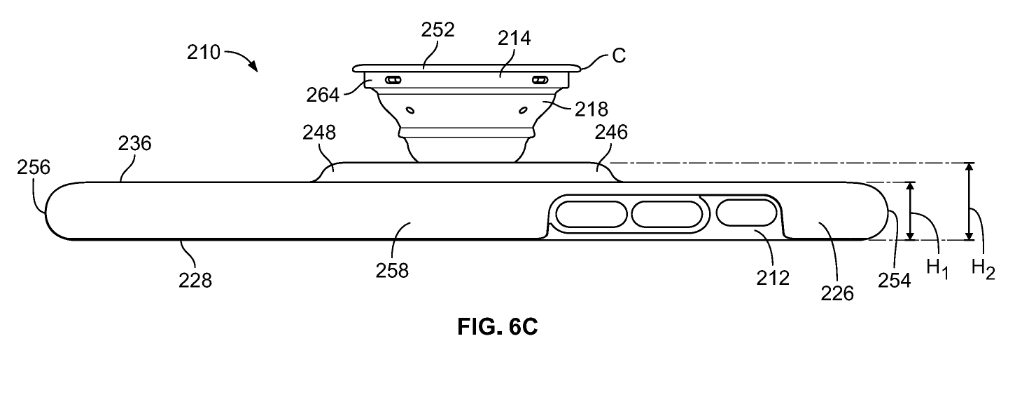

In FIGS. 5, 6A, 6B, and 6C, a third exemplary case assembly 210 for a portable electronic device 212 is constructed in accordance with the teachings of the present disclosure. Similar to the second exemplary case assembly 110 of FIGS. 3 and 4, the third exemplary case assembly 210 includes a case body 224 having an interior shell 225 and an exterior shell 226 that is sized to fit over the interior shell 225. Thus, for ease of reference and to the extent possible, the same or similar components of the case 210 will retain the same reference numbers as outlined above with respect to the second exemplary case 110, although the reference numbers will be increased by 100. A description of many of these elements is abbreviated or even eliminated in the interest of brevity. However, unlike the second exemplary case 110, the exterior shell 226 includes a buffer 246 that is sized and shaped to fit around a buffer 244 formed in the interior case body 224.

As shown in FIG. 5, the case body 224 includes the interior shell 225 and the exterior shell 226. The first buffer 244 may be integrally formed with the interior shell 225 and the second buffer 246, which may be integrally formed with the exterior shell 226, at least partially defines an exterior surface 236 of the case body 224. As shown in FIGS. 6A-6C, the first and second buffers 244, 246 surround an aperture 232 formed in the case body 224. The buffer 246 of the exterior shell 226 includes a wall 248 arranged to surround an end 222 of a device body 218 when the expandable device 214 is coupled to the case body 224. Further, the buffer 246 surrounds a circumference C of the device body 218 when the expandable device 214 is in the collapsed configuration, as shown in FIG. 6B. The buffer wall 248 of the buffer 246 may be curved to provide a sloped portion of the exterior surface 236, and extends from a height H1 to a height H2 adjacent the aperture 232. In another example, the wall 248 of the buffer 246 may define a different shape of the exterior surface 236 of the case body 224, which provides a smooth barrier to improve pocketability. While not depicted, it will be appreciated that the buffer 244 may be similarly constructed with similar components as the buffer 246 of the case body 224. However, in other examples, the inner shell 225 may be formed without the buffer 244.

FIG. 7 illustrates a fourth exemplary case assembly 310 for a portable electronic device constructed in accordance with the teachings of the present disclosure. The fourth exemplary case assembly 310 is similar to the third exemplary case 210 described above, thus for ease of reference and to the extent possible, the same or similar components of the fourth exemplary case 310 in FIG. 7 will retain the same reference numbers as outlined above with respect to the third exemplary case 210, although the reference numbers will be increased by 100. A description of many of these elements is abbreviated or even eliminated in the interest of brevity. However, the fourth exemplary case assembly 310 differs from the third exemplary case assembly 210 in the manner discussed below.

The case assembly 310 includes an expandable device 314 that is removably coupled to a case body 324 by sliding the expandable device 314 from a first position away from an aperture 332 formed in the case body 324 to a second position adjacent the aperture 332, as shown in FIG. 7. To assemble the case 310, the expandable device 314 may be moved in a direction J so that a platform 340 of the expandable device 314 slides into a space 370 defined between a base 338 of the case body 324 and a buffer 344 surrounding the aperture 332. The base 338 may be part of the case body 324 or may be separate from the case body 324. In some examples, the base 338 may be a surface of a portable electronic device. The aperture 332 is partially defined by a buffer wall 348, which defines a sloped exterior surface 336 of the case body 324 and extends at an incline from a first location away from the aperture 332, such as an outer perimeter P of the case body 324, to a second location adjacent to the aperture 332. The space 370 defined between the base 338 and the buffer 344 may be sized to receive a thickness of the platform 340. Alternatively, the case body 324 may be made of a deformable material such that the platform 340 can displace the buffer 344 when the platform 340 slides into the space 370 to move the expandable device 314 to the second position. In this example, the expandable device 314 includes the platform 340 secured to the end of the device body 318 such that the expandable device 314 may be completely removed out of the aperture 332 and away from the case body 314 by sliding the platform 340 in a direction opposite from the J direction. However, in another example, the platform 340 may instead be secured to the case body 324 and removably coupled to the end 322 of the device body 318. While not shown, it will be appreciated that when the expandable device 314 is in the collapsed configuration, the buffer 344 provides a smooth sloped surface 336 to match or substantially match a height of the collapsed expandable device 314.

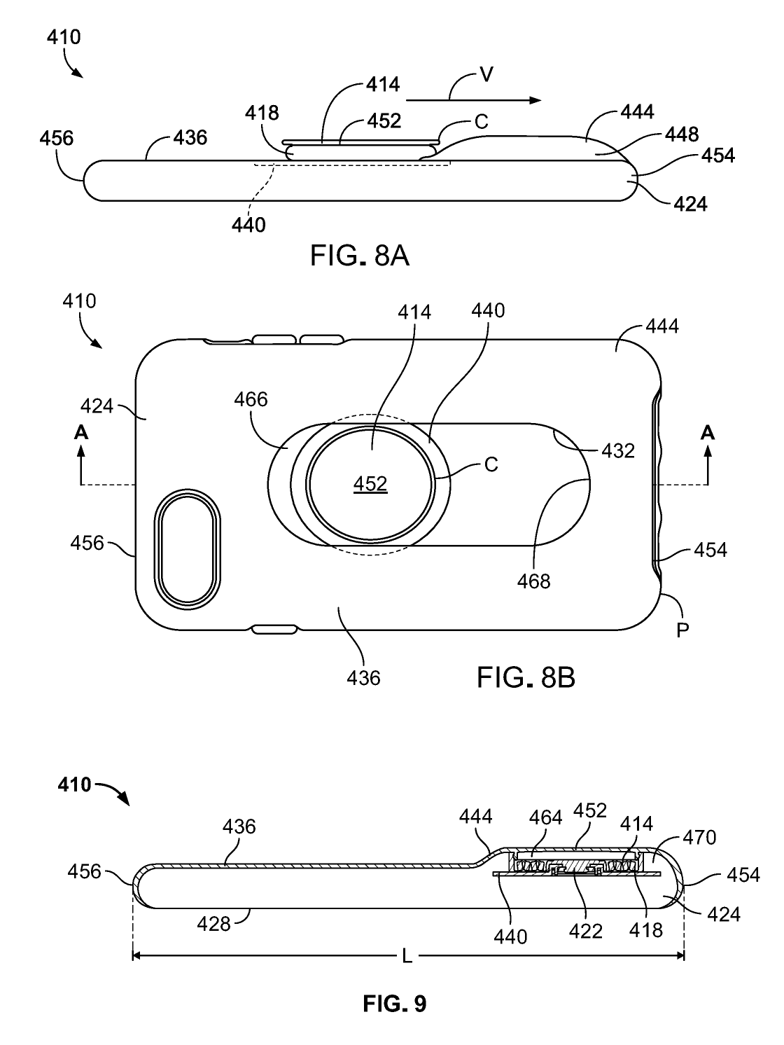

FIGS. 8A, 8B, and 9 illustrate a fifth exemplary case assembly 410 for a portable electronic device constructed in accordance with the teachings of the present disclosure. The fifth exemplary case 410 is similar to the fourth exemplary case 310 described above, thus for ease of reference and to the extent possible, the same or similar components of the fifth exemplary case 410 in FIGS. 8A, 8B, and 9 will retain the same reference numbers as outlined above with respect to the fourth exemplary case 310, although the reference numbers will be increased by 100. A description of many of these elements is abbreviated or even eliminated in the interest of brevity. However, the fifth exemplary case 410 differs from the fourth exemplary case 310 in the manner discussed below.

In this example, an expandable device 414 is slidably coupled to a case body 424. A platform 440 is disposed beneath a second or exterior surface 436 of the case body 424 and is slidable such that a device body 418 of the expandable device 414 can move between a first end 466 and a second end 468 of an aperture 432. A buffer 444 at least partially surrounds the second end 468 of the aperture 432 of the case body 424, and includes a wall 448 that extends at an incline to define a slope of the second surface 436 of the case body 424. The buffer 444 is adjacent to an end 454 of the case body 424. The platform 440 is movable in the aperture 432 in a direction V between a first position adjacent the first end 466 of the aperture 432, as shown in FIGS. 8A and 8B, and a second position adjacent the second end 468 of the aperture 432, as shown in FIG. 9. The buffer wall 448 substantially surrounds the expandable device 414 when the expandable device 414 is in the collapsed configuration and in the second position.

The case assembly 410 is designed to move the expandable device 414 between an accessible or first position for use, as shown in FIGS. 8A and 8B, and a storage or second position for pocketing the assembly 410, as shown in FIG. 9. The case 410 may be assembled by angling the platform 440 relative to the aperture 432 so that the platform 440 can slide beneath the second surface 436 of the case body 424 and against an electronic device or base. Alternatively, a first end 464 of the expandable device 414 may be sized to slide or push through the aperture 432 from an interior or first surface 428 of the case body 424. The platform 440 catches against the case body 424 and remains below the aperture 432 because a diameter of the platform 440 is wider than a width of the aperture 440. The platform 440 is adapted to slide against an outer surface of a portable electronic device or against a base disposed between the portable electronic device and the exterior surface 436 of the case body 424. It will be appreciated that when the expandable device 414 is in the collapsed configuration, the buffer 444 provides a smooth sloped exterior surface 436 to match or substantially match a height of the collapsed expandable device 414. As shown in FIG. 9, the buffer 444 forms a cavity 470 having a volume sized to at least partially enclose the expandable device 414 and cover at least a portion of a button 452 when the expandable device 414 is in the second position and in the collapsed configuration. In the illustrated example, the button 452 of the expandable device 414 has smaller diameter than the diameter of the platform 440. However, in other examples the button 452 may have the same diameter or a larger diameter than the diameter of the platform 440.

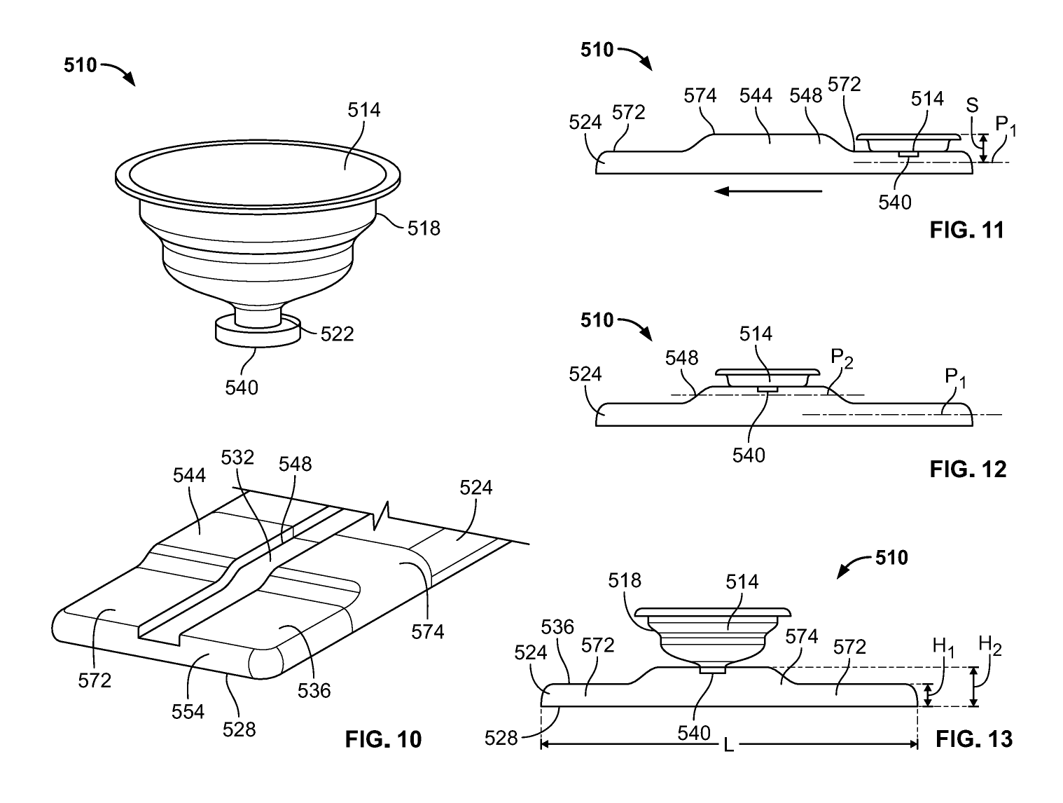

FIGS. 10-13 illustrate a sixth exemplary case assembly 510 for a portable electronic device constructed in accordance with the teachings of the present disclosure. The sixth exemplary case assembly 510 is similar to the fifth exemplary case assembly 410 described above, thus for ease of reference and to the extent possible, the same or similar components of the sixth exemplary case 510 in FIGS. 10-13 will retain the same reference numbers as outlined above with respect to the fifth exemplary case 410, although the reference numbers will be increased by 100. A description of many of these elements is abbreviated or even eliminated in the interest of brevity. However, the sixth exemplary case 510 differs from the fifth exemplary case 410 in the manner discussed below.

In this example, an expandable device 514 is movable relative to a case body 524 in a direction perpendicular relative to a first face 528 of the case body 524 between a first position and a second position. The case body 524 includes a first stepped area 572 and a second stepped area 574 raised relative to the first stepped area 572 formed in an exterior or second face 536 of the case body 524. An aperture 532 formed in the second face 532 defines a track extending along a length of the case body 524 and at least partially through the first stepped area 572 and the second stepped area 574 of the case body 524. A buffer 544 at least partially surrounds the aperture 532 of the case body and includes a wall 548 arranged to surround an end 522 of a device body 518 when the expandable device 514 is coupled to the case body 524, as shown in FIGS. 11-13. The wall 548 slopes from the first stepped area 572 of a height H1 to the second stepped area 574 of a height H2. In operation, the expandable device 514 is movable in the track between a first position, as shown in FIG. 11, in which a portion of the device body 518 is disposed in the first stepped area 572, and a second position, as shown in FIGS. 12 and 13, in which the portion of the device body 518 is disposed in the second stepped area 574. The track is configured to guide the expandable device 514 in the perpendicular direction as the end 522 of the device body 518 moves across the length of the case body 524.

The case assembly 510 is designed to move the expandable device 514 between a storage or first position for pocketing, as shown in FIG. 11, and an accessible or second position for use, as shown in FIGS. 12 and 13. In the first position, the end 522 of the device body 518 is disposed on a first reference plane P1. A height S of the collapsed expandable device 514 is substantially level with the height H2 of the buffer wall 548 of the second stepped area 574. In the second position, the end 522 of the device body 518 is disposed on a second reference plane P2. As shown in FIGS. 11 and 12, the second reference plane P2 is parallel and spaced away from the first reference plane P1. In this example, the end 522 of the device body 518 includes a platform 540 sized to fit within the track of the aperture 532. The platform 540, which is wider than the aperture 532, slides into the track at an end 554 of the case body 524. In another example, the end 522 of the device body 518 may be directly coupled to the case body 524.

FIGS. 14-16 illustrate a seventh exemplary case assembly 610 for a portable electronic device constructed in accordance with the teachings of the present disclosure. The seventh exemplary case 610 is similar to the sixth exemplary case 510 described above, thus for ease of reference and to the extent possible, the same or similar components of the seventh exemplary case 610 in FIGS. 14-16 will retain the same reference numbers as outlined above with respect to the sixth exemplary case 510, although the reference numbers will be increased by 100. A description of many of these elements is abbreviated or even eliminated in the interest of brevity. However, the seventh exemplary case 610 differs from the sixth exemplary case 510 in the manner discussed below.

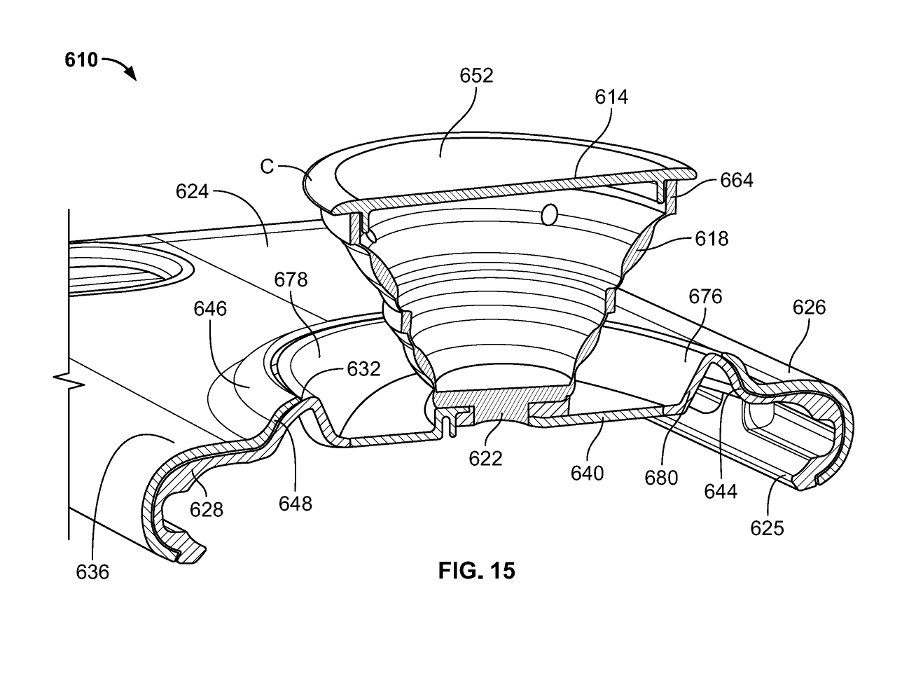

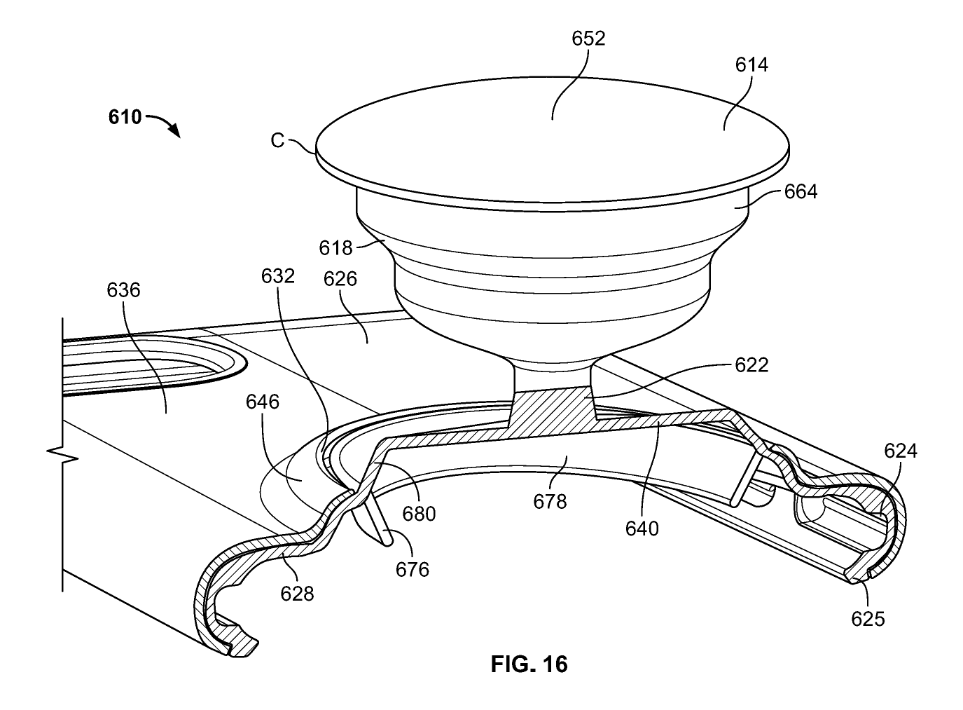

In this example, a case body 624 may be similar to the case bodies 124, 224 of the second and third case assemblies 10, 110 discussed above, and includes an interior case or shell 625 and an exterior shell 626. The interior case 625 includes a buffer 644 curving away from a generally flat exterior surface to define an aperture 632. The buffer 644 of the interior case 625 includes a flexible member 676, which has a collar 678 and a joint 680. The collar 678 of the flexible member 676 is disposed in an aperture 632 formed in the case body 624, and extends around a circumference C of an expandable device 614 when the expandable device 614 is in the collapsed configuration, as shown in FIG. 14. The joint 680 of the flexible member 676 connects the collar 678 with a platform 640 of the expandable device 614. The platform 640 may be configured to removably couple or lock to an end 622 of a device body 618 of the expandable device 614 by rotating, sliding, or press-fitting the device body 618 into and out of the platform 640. As shown in FIGS. 14 and 15, the expandable device 614 is in a first position, in which the end 622 of the device body 618 is proximally located to a first face 628 of the case body 624. In FIG. 16, the end 622 of the device body 618 is spaced away from the first face 628 of the case body 624.

As more clearly shown in FIGS. 15 and 16, the joint 680 is connected to an outer edge of the platform 640 and is configured to move the platform 640, and therefore the expandable device 614, between first and second positions. In FIG. 15, the joint 680 is in a collapsed arrangement such that the device body 618 is in a first position and the end 622 of the device body 618 is disposed below a second surface 636 of the case body 624. In FIG. 16, the joint 680 is in an extended arrangement such that the device body 618 is in a second position and the end 622 of the device body is disposed above the second surface 636. So configured, when a user pulls the expandable device 614 in an upward direction and away from the case body 624, the flexible member 676 bends such that the joint 680 becomes extended, thereby permitting the platform 640 to lift up and out of the aperture 632 formed in case body 624. When the joint 680 is in the extended configuration, the joint 680 may provide some rigidity so that the expandable device 614 can remain in the second position until a user pushes the expandable device 614 back through the aperture 632 and into the first position. In this example, a user may use the full extension of the expandable device 614 when the expandable device 614 is lifted at least partially out of the aperture 632 formed in the case 610. In another example, the joint 680 may not provide rigidity so that when a user releases the expandable device 640, the joint 680 returns to its initial arrangement and pulls the platform 640 back into the aperture 632 of the case body 624. The flexible member 676 is preferably made of a resilient material such that the joint 680 may return to its initial shape without sustaining substantial permanent deformation. For example, a resilient material may be a polyester-based thermoplastic polyurethane elastomer, that may be formed by injection molding, thermoforming, or compression molding, or may be any equivalently functional material suitable for its intended purpose.

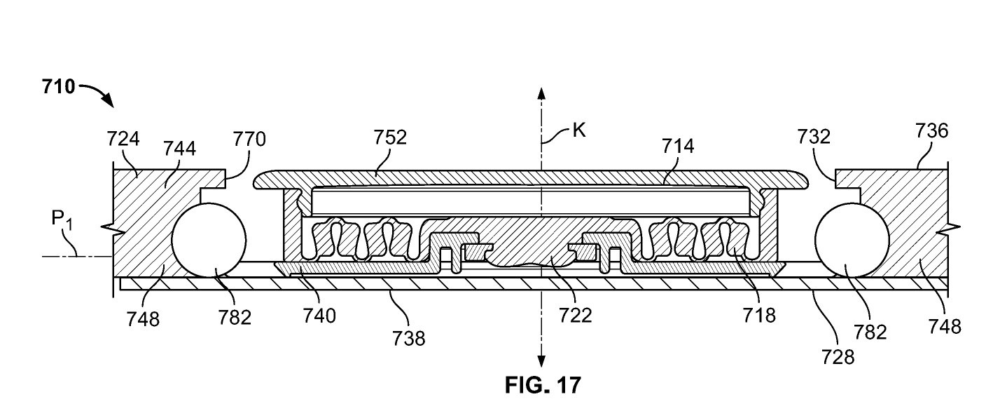

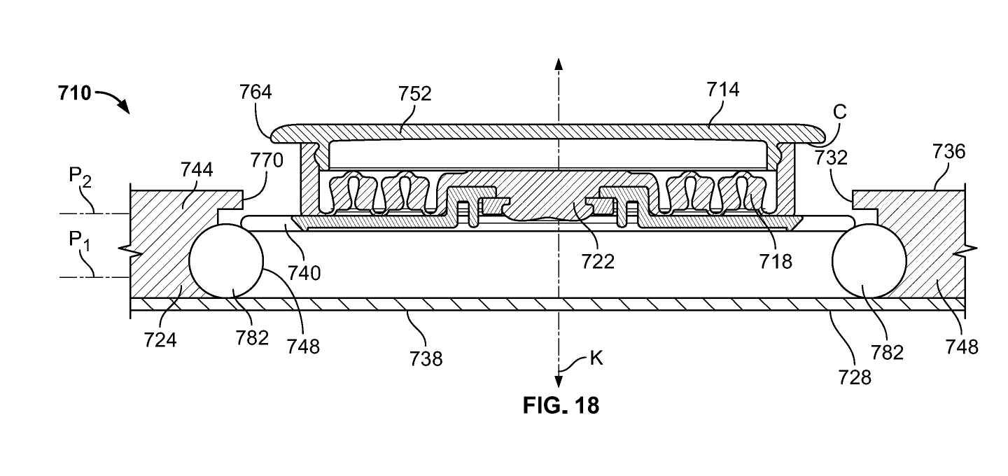

FIGS. 17 and 18 illustrate an eighth exemplary case assembly 710 for a portable electronic device constructed in accordance with the teachings of the present disclosure. The eighth exemplary case 710 is similar to the seventh exemplary case 610 described above, thus for ease of reference and to the extent possible, the same or similar components of the eighth exemplary case 710 in FIGS. 17 and 18 will retain the same reference numbers as outlined above with respect to the seventh exemplary case 610, although the reference numbers will be increased by 100. A description of many of these elements is abbreviated or even eliminated in the interest of brevity. However, the eighth exemplary case 710 differs from the seventh exemplary case 610 in the manner discussed below.

The case assembly 710 of FIGS. 17 and 18 includes an air pocket 782 disposed in an aperture 732 of a case body 724 to move an expandable device 714 between a first position, as shown in FIG. 17, and a second position, as shown in FIG. 18. The air pocket 780 may be an inflatable ring or may include multiple components spaced around a circumference C of the expandable device 714. The air pocket 782 is adapted to engage with the expandable device 714, and more specifically, a platform 740 of the expandable device 714, when a device body 718 is disposed in the first position, while the device body 718 is moving to the second position, and when the device body 718 is in the second position. The air pocket 782 is deformable between an inflated configuration and a deflated configuration such that an end 722 of the device body 718 is movable through the aperture 732 of the case body 724 between the first and the second positions. In the first position, the air pocket 782 is disposed between a base 728 of the case body 724, a buffer wall 748, and a second surface 736 of the case body 724. In this position, the air pocket 782 extends slightly inwardly into the aperture 732 such that the air pocket 782 applies a pressure to keep the platform 740 against the base 728 of the case body 724. When the air pocket 782 is inflated, the air pocket 782 has a round cross-sectional shape, and slightly deforms around the platform 740 when the device body 718 moves in a vertical direction K. When the air pocket 782 engages the platform 740, the air pocket 782 deforms by partially deflating and releasing air through a valve. Once the platform 740 reaches the second position and is disposed in a cavity 770 of the case body 724, the air pocket 782 may inflate by drawing air through the valve. In FIG. 18, the inflated air pocket 782 supports the expandable device 714 in the second position.

The case assembly 710 provides the base 728 to support the expandable device 714 when the expandable device 714 is in the first position. However, in other examples, the platform 740 may instead contact an exterior surface of an electronic device. The buffer 744 may be similar to any of the buffers 44, 144, 244 of the first, second, and third case assemblies 10, 110 of FIGS. 1-6C. While not illustrated, it will be appreciated that the buffer wall 748 may define a sloped exterior surface 736 of the case body 724, an indent adjacent the aperture 732, or other arrangement.

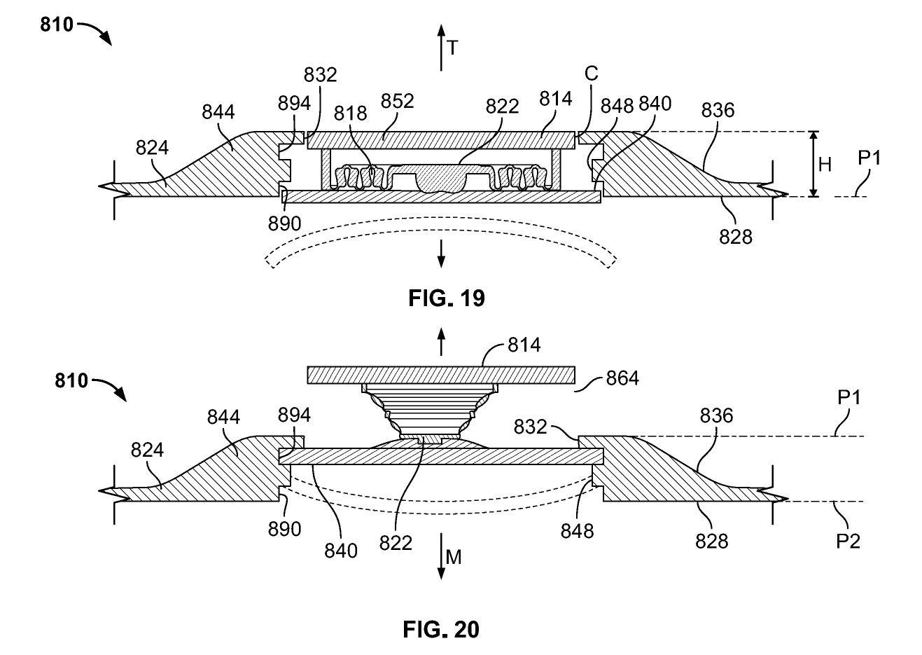

FIGS. 19 and 20 illustrate a ninth exemplary case assembly 810 for a portable electronic device constructed in accordance with the teachings of the present disclosure. The ninth exemplary case 810 is similar to the eighth exemplary case 710 described above, thus for ease of reference and to the extent possible, the same or similar components of the ninth exemplary case 810 in FIGS. 19 and 20 will retain the same reference numbers as outlined above with respect to the eighth exemplary case 710, although the reference numbers will be increased by 100. A description of many of these elements is abbreviated or even eliminated in the interest of brevity.

The ninth exemplary case assembly 810 is similar to the eighth exemplary case assembly 710 discussed above, and includes a flexible member or platform 840 connected to a case body 824 and to an end 822 of an expandable device 814. The platform 840 is movable between a first configuration, as shown in FIG. 18, and a second configuration, as shown in FIG. 19, to move the end 822 of the expandable device 814 through an aperture 832 formed in the case body 824. In the illustrated example, a buffer wall 848 at least partially defines the aperture 832 and has a height H to match a height of a collapsed expandable device 814 when coupled to the case body 824. In the aperture 832, the wall 848 defines a first annular groove 890 and a second annular groove 894 that is vertically spaced from the first groove 890. As shown in FIG. 19, the platform 840 of the expandable device 814 is disposed in the first groove 890, and the expandable device 814 is in a collapsed configuration such that a button 852 of the expandable device 814 is substantially level with the wall 848 of a buffer 844. However, unlike the eighth exemplary case assembly 710 of FIGS. 17 and 18, the case assembly 810 of the illustrated example does not provide a base to support the expandable device 814 when the expandable device 814 is in the first position. Instead, the case assembly 810 is configured such that an exterior surface of an electronic device supports the platform 840. However, in other examples, the case assembly 810 may include a base between the electronic device and the platform 840.

The expandable device 814 is movably coupled to the case body 824 by snap-fit connection. The platform 840 is a flexible member and may be made of a resilient (e.g. deformable, flexible, pliable) material that flexes or bends, as shown by the dashed lines, to move the expandable device 814 between the first and second positions. The platform 840 is adapted to curve to move out of the first groove 890 and snap into the second groove 894 when the expandable device 814 is pulled upward in a vertical direction T. The platform 840 may return to its initial shape without sustaining substantial permanent deformation. As shown in FIG. 20, the expandable device 814 is in the second position such that the platform 840 is disposed in the second groove 894. The platform 840 is adapted to deform or flex, as shown in the dashed lines, to curve to move out of the second groove 894 and snap into the first groove 890 when the expandable device 814 is pushed downward in a vertical direction M (opposite direction T). The platform 840 is preferably made of a resilient material, such as polyester-based thermoplastic polyurethane elastomer, that may be formed by injection molding, thermoforming, or compression molding, or may be any equivalently functional material suitable for its intended purpose.

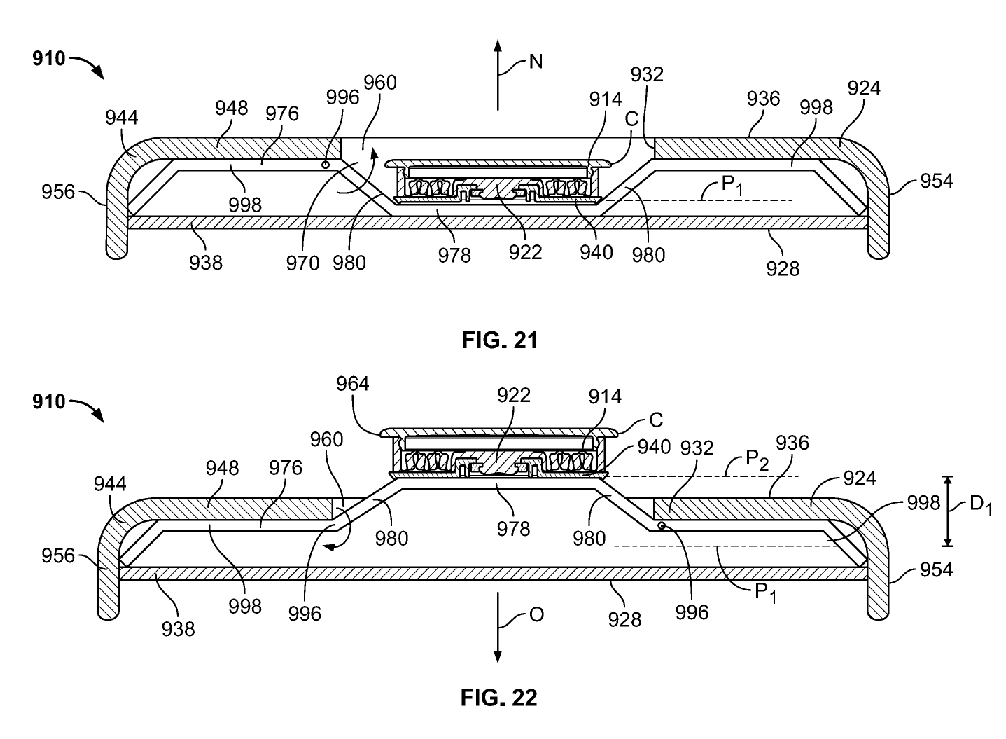

FIGS. 21 and 22 illustrate a tenth exemplary case assembly 910 for a portable electronic device constructed in accordance with the teachings of the present disclosure. The tenth exemplary case 910 is similar to the ninth exemplary case 810 described above, thus for ease of reference and to the extent possible, the same or similar components of the tenth exemplary case 910 in FIGS. 21 and 22 will retain the same reference numbers as outlined above with respect to the ninth exemplary case 810, although the reference numbers will be increased by 100. A description of many of these elements is abbreviated or even eliminated in the interest of brevity. However, the tenth exemplary case 910 differs from the ninth exemplary case 810 in the manner discussed below.

The tenth exemplary case assembly 910 is similar to the eighth and ninth exemplary case assemblies 710 and 810 discussed above, and includes a flexible member 976 connected to a case body 924 and to an end 922 of an expandable device 914. The flexible member 976 is movable between a first configuration, as shown in FIG. 20, and a second configuration, as shown in FIG. 21 to move the end 922 of the expandable device 914 through an aperture 932 formed in the case body 924. The flexible member 976 is configured to bend or flex away from and toward the aperture 932 to move the expandable device 914 between a first position and a second position, respectively. In FIG. 21, the expandable device 914 is in the first position and a device body 918 is disposed in the aperture 932. FIG. 22 shows the device body 918 in a second position in which the expandable device 914 is disposed above the aperture 932. The flexible member 976 flexes away and toward the aperture 932 by pulling or pushing the expandable device 914 between first and second positions. The flexible member 976 is secured to the expandable device 914 by a platform 940, which may be removably coupled to the end 922 of the device body 918, the case body 924 via the flexible member 976, or both the device body 918 and the case body 924.

The flexible member 976 has a semi-rigid body capable of snapping back and forth when the expandable device 914 is pulled in a vertical direction N or pushed in a vertical direction O. In particular, the flexible member 976 includes a central portion 978 secured to the end 922 of the expandable device 914 and remains flat. Flex joints 980 extend from either side of the central portion 978, and are adapted to pivot about a pivot point 996 to move the central portion 978 between first and second configurations. The flex joints 980 are connected to arms 998 that extend from the flex joints 980 toward first and second sides 954 and 956 of the case body 924. The case assembly 910 provides a base 928 to support the arms 998. However, in other examples, the arms 998 of the flexible member 976 may instead contact an exterior surface of an electronic device. In yet another example, the flexible member 976 may be integrally formed with the case body 924.

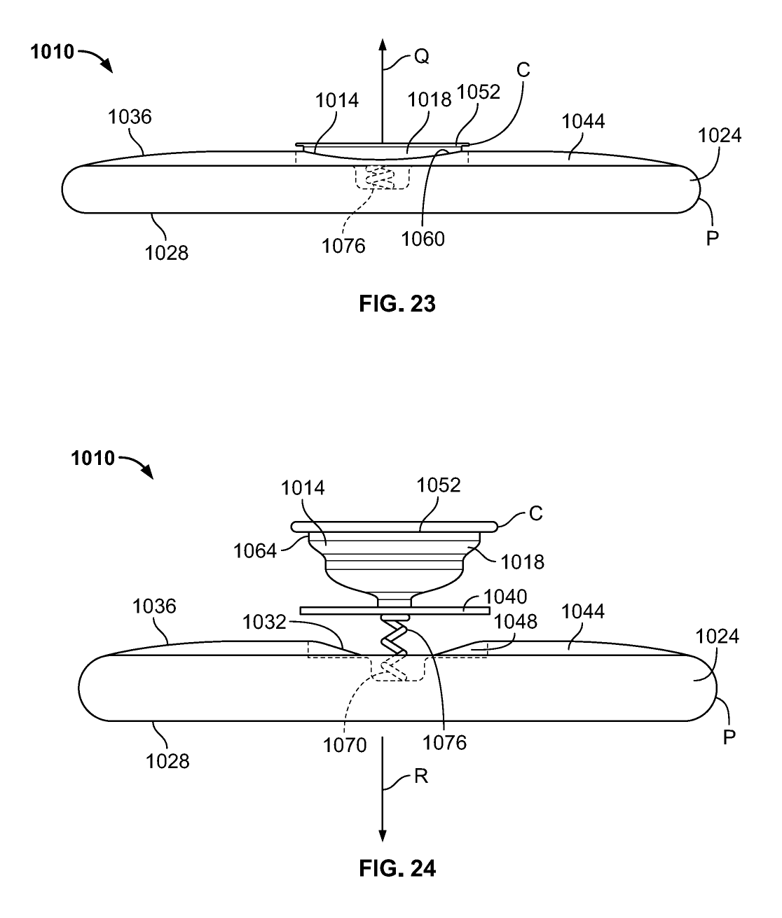

FIGS. 23 and 24 illustrate an eleventh exemplary case assembly 1010 for a portable electronic device constructed in accordance with the teachings of the present disclosure. The eleventh exemplary case 1010 is similar to the tenth exemplary case 910 described above, thus for ease of reference and to the extent possible, the same or similar components of the eleventh exemplary case 1010 in FIGS. 23 and 24 will retain the same reference numbers as outlined above with respect to the tenth exemplary case 910, although the reference numbers will be increased by 100. A description of many of these elements is abbreviated or even eliminated in the interest of brevity. However, the eleventh exemplary case 1010 differs from the tenth exemplary case 910 in the manner discussed below.

The eleventh exemplary case assembly 1010 may be similar to the first exemplary case assembly 10, and includes an indent 1060 defined by a buffer 1044. Unlike the first exemplary case assembly 10, the illustrated case assembly 1010 of FIGS. 23 and 24 includes a compression spring 1076 disposed beneath an end 1022 of a device body 1018, and is movable between a compressed arrangement, as shown in FIG. 23, and an expanded arrangement, as shown in FIG. 24. The spring 1076 is disposed in a cavity 1070 formed in a case body 1024, and includes a release mechanism that, when activated, releases the compression spring from the compressed configuration to move an expandable device 1014 in a vertical direction Q from a first position to a second position. To move the expandable device 1014 back to the first position, a user may push down on the expandable device 1014 in a vertical direction R, compressing the compression spring 1076 until the release mechanism locks the compression spring in the compressed configuration.

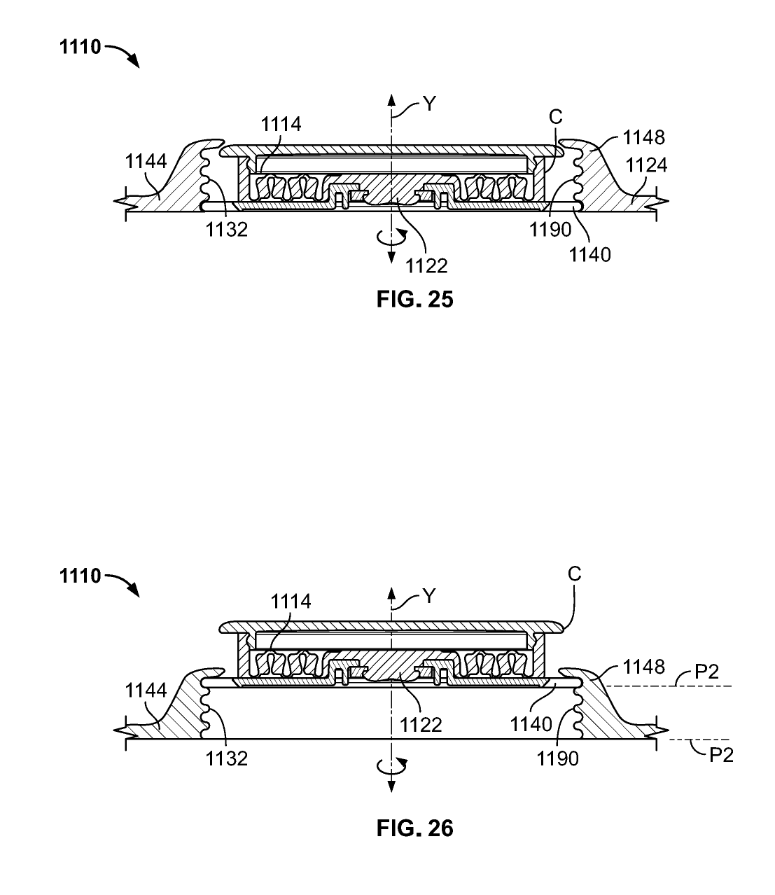

FIGS. 25 and 26 illustrate a twelfth exemplary case assembly 1110 for a portable electronic device constructed in accordance with the teachings of the present disclosure. The twelfth exemplary case 1110 is similar to the eleventh exemplary case 1010 described above, thus for ease of reference and to the extent possible, the same or similar components of the twelfth exemplary case 1110 in FIGS. 25 and 26 will retain the same reference numbers as outlined above with respect to the eleventh exemplary case 1010, although the reference numbers will be increased by 100. A description of many of these elements is abbreviated or even eliminated in the interest of brevity. However, the twelfth exemplary case 1110 differs from the eleventh exemplary case 1010 in the manner discussed below.

The case assembly 1110 in FIGS. 25 and 26 permits a user to move an expandable device 1114 from a first position, as shown in FIG. 25, to a second position, as shown in FIG. 25, by rotating the expandable device 1114 about a central axis Y. An aperture 1132 includes a threaded surface 1190 and the expandable device 1114, via a platform 1140, threadably engages the threaded surface 1190. The expandable device 1114 moves in a perpendicular direction relative to a case body 1124 when the expandable device 1114 rotates relative to the case body 1124. The case assembly 1110 of the illustrated example does not provide a base to support the expandable device 1114 when the expandable device 1114 is in the first position. Instead, the case assembly 1110 is configured such that an exterior surface of an electronic device supports the platform 1140. However, in other examples, the case assembly 1110 may include a base between the electronic device and the platform 1140.

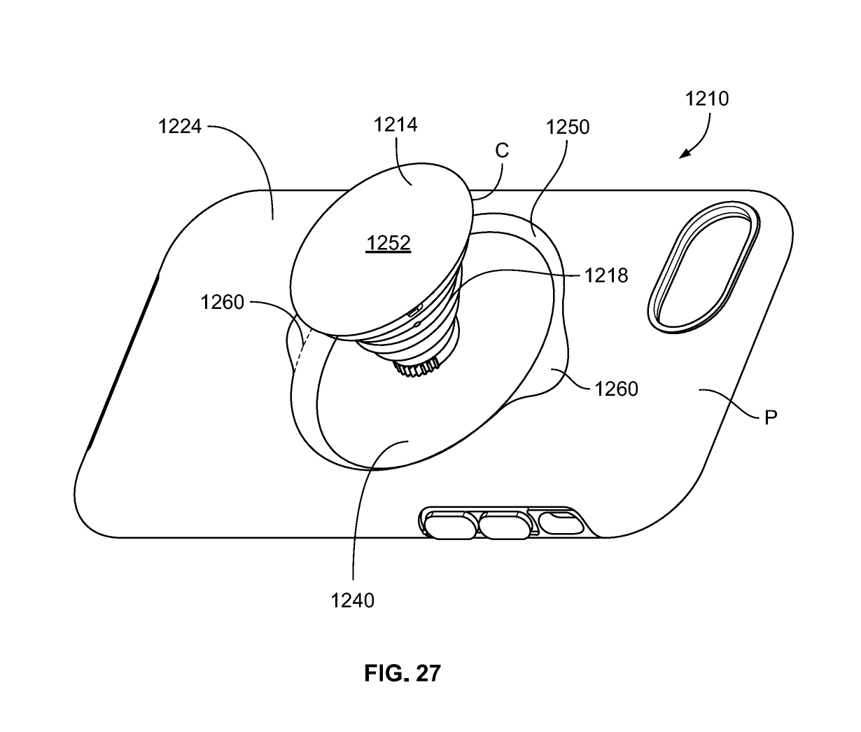

FIG. 27 illustrates a thirteenth exemplary case assembly 1210 for a portable electronic device constructed in accordance with the teachings of the present disclosure. The thirteenth exemplary case assembly 1210 is similar to the second exemplary case 110 of FIG. 3 described above, thus for ease of reference and to the extent possible, the same or similar components of the thirteenth exemplary case 1210 in FIG. 27 will retain the same reference numbers as outlined above with respect to the second exemplary case 110, although the reference numbers will be increased by 1100. A description of many of these elements is abbreviated or even eliminated in the interest of brevity.

The case assembly 1210 of FIG. 27 provides a case body 1224 including a bore or opening 1250 that is sized to fit around a circumference C of an expandable device 1214. A platform 1240 of the expandable device 1214 is removably attached to a portable electronic device received in the case body 1224. That is, the case body 1224 may be coupled to a portable electronic device, and the expandable grip accessory 1214 may be attached to a surface of the portable electronic device after the case body 1224 is coupled to the portable electronic device. The bore 1250 provides a clearance to permit a user to easily attach or remove the platform 1240 of the expandable device 1214 from the portable device while the case body 1224 remains secured to the portable device. The bore 1250 includes opposing recessed portions 1260 for facilitating grasping a button 1252 of the expandable device 1214 to move the expandable device 1214 from a collapsed configuration to an expanded configuration. In another example, the expandable grip accessory 1214 may be attached to the portable electronic device, and then the case body 1224 may be attached by aligning the bore 1250 with the expandable grip accessory 1214 to secure the case body 1224 to the portable device. So configured, when the expandable device 1214 is in the collapsed configuration, a portion of the expandable device 1214 is disposed below an outer surface of the case body 1224 and within the bore 1250. In this way, the expandable grip accessory 1214 minimally protrudes away from the case body 1224 such that the case assembly 1210 has improved pocketability.

Any one of the case assemblies 10, 110, 210, 310, 410, 510, 610, 710, 810, 910, 1010, 1110, 1210 are configured to improve pocketability of an expandable device coupled to a portable electronic device. Improving pocketability facilitates pocketing a portable electronic device into a pocket, e.g. pocket of a garment or a sleeve of a bag, so that a user may easily slide the case into the pocket without catching the case or expandable device along the way. Additionally, improving the pocketability may increase the comfort in which the electronic device and attached expandable device sits within the pocket. The case assembly 10, 110, 210, 310, 410, 510, 610, 710, 810, 910, 1010, 1110, and 1210 of each disclosed example may improve pocketability of a case for a portable electronic device and expandable device by either buffering the area around the expandable device so that the expandable device does not protrude far the from outer surface of the case, and/or coupling the device to the case such that the device may move between a storage position and an accessible position In doing so, an exterior surface of each disclosed case protects the expandable device when the case is being pocketed.

The figures and description provided herein depict and describe preferred examples of a portable electronic case for purposes of illustration only. One skilled in the art will readily recognize from the foregoing discussion that alternative examples of the components illustrated herein may be employed without departing from the principles described herein. Thus, upon reading this disclosure, those of skill in the art will appreciate still additional alternative structural and functional designs for expandable devices and cases that improve the pocketability of the attached expandable device. Thus, while particular examples and applications have been illustrated and described, it is to be understood that the disclosed examples are not limited to the precise construction and components disclosed herein. Various modifications, changes and variations, which will be apparent to those skilled in the art, may be made in the arrangement, operation and details of the methods and components disclosed herein without departing from the spirit and scope defined in the appended claims.

1. A case assembly for a portable electronic device, the assembly comprising:
an expandable device including a device body having an end;
a case body arranged to receive a portable electronic device on a first face and including an aperture formed in a second face opposite the first face, the aperture sized to receive at least a portion of the expandable device;
a buffer at least partially surrounding the aperture of the case body and including a wall extending away from the first face of the case body, the wall arranged to surround at least a portion of the device body when the expandable device is coupled to the case body; and
wherein the device body is movable within the aperture from a first position to a second position.

2. The assembly of claim 1, wherein the device body includes a flexible wall that is movable between a collapsed configuration and an extended configuration, the buffer at least partially surrounding the flexible wall when the expandable device is in the collapsed configuration.

3. The assembly of claim 1, wherein the end of the device body is slidably coupled to the case body in the aperture between the first position and the second position.

4. The assembly of claim 1, wherein the end of the device body is movable in a direction perpendicular relative to the first face of the case body between the first position and the second position.

5. The assembly of claim 1, wherein the end of the device body is disposed on a first reference plane when the device body is in the first position, and wherein the end of the device body is disposed on a second reference plane when the device body is in the second position, the second reference plane parallel and spaced away from the first reference plane.

6. The assembly of claim 1, wherein the end of the device body is proximally located to the first face of the case body when the device body is disposed in the first position, and the end of the device body is spaced away from the first face of the case body when the device body is disposed in the second position.

7. The assembly of claim 1, further comprising:
a flexible member connected to the case body and coupled to the end of the device body, the flexible member movable between a first configuration and an second configuration; and
wherein the end of the device body is movable through the aperture of the case body when the flexible member moves between the first configuration and the second configuration.

8. The assembly of claim 7, wherein the flexible member is a pliable joint disposed within the aperture, and is movable between a collapsed arrangement in the first configuration and an extended arrangement in the second configuration.

9. The assembly of claim 7, wherein the flexible member is a compression spring disposed beneath the end of the device body, and is movable between a compressed arrangement in the first configuration and an expanded arrangement in the second configuration.

10. The assembly of claim 7, wherein the flexible member is coupled to the case body by snap-fit connection and includes a resilient material that bends to move the device body between the first position and the second position.

11. The assembly of claim 1, wherein the case body includes an inner threaded surface disposed adjacent the aperture, the expandable device rotatably coupled to the threaded surface and is movable in a perpendicular direction relative to the case body when the expandable device rotates relative to the case body.

12. The assembly of claim 1, further comprising:
an inflatable air pocket disposed in the aperture of the case body and adapted to engage with the expandable device, the air pocket deformable between an inflated configuration and a deflated configuration such that the end of the device body is movable through the aperture of the case body between the first position and the second position.

13. The assembly of claim 2, wherein the buffer extends substantially around a circumference of the device body when the expandable device is in the collapsed configuration.

14. The assembly of claim 2, wherein the expandable device includes a platform coupled to the end of the device body and coupled to the case body.

15. The assembly of claim 14, wherein the platform is removably attached to at least one of the case body and the end of the device body.

16. The assembly of claim 14, wherein the buffer wall defines a sloped exterior surface of the case body extending at an incline from a first location away from the aperture to a second location adjacent to the aperture.

17. The assembly of claim 14, wherein the buffer is integrally formed with the case body.

18. The assembly of claim 14, wherein the case body includes an interior shell and an exterior shell sized to wrap around the interior shell of the case body, and wherein at least one of the interior shell and the exterior shell at least partially defines the buffer.

19. The assembly of claim 14, wherein the buffer includes an indent positioned adjacent to the aperture.

20-35. (canceled)

36. A case assembly for a portable electronic device, the assembly comprising:
an expandable device including a device body having an end and a flexible wall that is movable between a collapsed configuration and an extended configuration;
a case body structured to receive a portable electronic device and including an aperture sized to receive at least a portion of the expandable device;
a platform coupled to the end of the device body and movably coupled to the case body; and
a buffer at least partially surrounding the aperture of the case body and including a wall arranged to surround the end of the device body when the expandable device is coupled to the case body.

37. The case assembly of claim 36,
wherein the buffer surrounds a circumference of the device body when the expandable device is in the collapsed configuration.

38. The case assembly of claim 36,
wherein at least a portion of the expandable device is slidable within the aperture between a first position and a second position, the buffer wall substantially surrounding the expandable device when the expandable device is in the first position;
wherein the buffer wall defines a sloped exterior surface of the case body extending at an incline from a first location away from the aperture to a second location adjacent to the aperture.

39. The case assembly of claim 36,
wherein the wall of the buffer extends at an incline to define a sloped exterior surface of the case body; and
wherein the platform is movable in the aperture between a first position and a second position, the buffer wall substantially surrounding the expandable device when the expandable device is in the collapsed configuration and in the first position.

40. The case assembly of claim 36,
wherein the case body includes a first stepped area, a second stepped area raised relative to the first stepped area, and the aperture defines a track extending at least partially through the first stepped area and the second stepped area;
wherein the expandable device is movable within the track between a first position, in which a portion of the device body is disposed in the first stepped area, and a second position, in which the portion of the device body is disposed in the second stepped area.

41. The case assembly of claim 36, further comprising:
a flexible joint connected to the platform, the flexible joint movable between a collapsed configuration in which the platform is disposed in an initial position in the aperture and an extended configuration in which the platform is disposed in a position above the initial position.

42. The case assembly of claim 36,
the case body further including an inflatable air pocket adjacent the aperture; and
an inflatable air pocket disposed in the aperture of the case body and adapted to engage with the expandable device, the air pocket deformable between an inflated configuration and a deflated configuration such that the end of the device body is movable through the aperture of the case body between a first position and a second position.

43. The case assembly of claim 36,
the aperture including a first groove and a second groove spaced from the first groove;
the platform movably coupled to the case body by snap-fit connection between the first groove and the second groove;
wherein the platform includes a resilient material and bends to move the expandable device between a first position, in which the platform is disposed in the first groove and a second position, in which the platform is disposed in the second groove.

44. The case assembly of claim 36, further comprising:
a flex band coupled to the platform and is movable relative to the aperture of the case body;
wherein the flex band is configured to flex away from the aperture to move the expandable device to a first position, in which the device body is disposed in the aperture, and is configured to flex toward the aperture, in which the device body is disposed above the aperture in a second position.

45. The case assembly of claim 36, further comprising:
a spring disposed within the aperture and coupled to the platform, the spring movable between a compressed configuration and an extended configuration such that the platform of the device body is movable through the aperture of the case body when the spring is in the extended configuration.

46. The case assembly of claim 36,
the aperture including a threaded surface;
wherein the expandable device is rotatably coupled to the threaded surface of the aperture and is movable in a perpendicular direction relative to the case body when the expandable device rotates relative to the case body.

47. The case assembly of claim 36, wherein the buffer includes an indent positioned adjacent to the aperture.
